(19) United States
(12) Patent Application Publication
(10) Pub. No.: US 2007/0220545 A1
(43) Pub. Date: Sep. 20, 2007

(54) Advertisement viewing confirmation system, broadcast receiving terminal, advertisement viewing confirmation terminal, advertisement viewing confirmation method and program

(75) Inventor: Jun Awano, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/711,733

(22) Filed: Feb. 28, 2007

(30) Foreign Application Priority Data
Mar. 1, 2006 (JP) 2006-055100

(51) Int. Cl. H04N 7/10; H04N 5/445; H04N 7/025; H04N 7/16; G06F 13/00; G06F 3/00

(52) U.S. Cl. 725/34; 725/42; 725/25

(57) ABSTRACT

A broadcast receiver terminal receives a broadcast program with advertisement ID information inserted therein, outputs the program, and transmits the ID information through proximity communication. An advertisement viewing confirmation terminal receives, if it is determined that a user is carrying about the confirmation terminal according to a temperature, the ID information through the proximity communication and then creates viewing information by adding user information to the advertisement ID information.

### BACKGROUND OF THE INVENTION

1. Field of the Invention

The present invention relates to a technique for enhancing the effect of advertisements inserted during a broadcast program or between broadcast programs.

2. Description of the Related Art

Conventionally, with wide spread of program recording apparatus such as a Hard Disk Drive (HDD), there increasingly occur situations in which a user (viewer) views broadcast programs, skipping commercial advertisements between broadcast programs or during a broadcast program transmitted from commercial broadcasting companies. This raises a fear of deterioration in the effect of commercial messages (CM) or advertisements.

For the commercial broadcasting companies, the income from the advertisements or CM occupies the most part of the income. Therefore, the reduction in the value of advertisements is an issue of critical importance for the companies. For the sponsors, there also appears an adverse effect that the cost performance of the advertisements lowers.

Generally, the viewer or user feels that viewing of advertisements is annoying. The user hence will skip the advertisements. In many cases, the viewer leaves his or her seat while advertisements are broadcasted or do other things other than viewing the advertisements. However, users are so accustomed to viewing programs for free thanks to advertisements that the users tend to think that broadcast programs are free of charge. Therefore, only a few users select pay broadcasting in which the advertisement is not inserted. On the other hand, if there is installed in the HDD recorder or the like a function to prevent the skipping of advertisements, the usability of the device quite deteriorates.

In consequence, a system that prompts a user to view advertisements is required.

In this connection, there has been known a broadcast program receiving system wherein a broadcasting company broadcasts both a program with advertisements and a program without advertisements so that the user can select either one of the programs. In addition, there has been proposed a technique wherein advertisements are extracted and separately accumulated so that a user later inserts a desired amount of the advertisements in a desired position of a broadcast program to view the advertisements. The viewing charge for the user is determined according to a period of time for the advertisements to thereby reduce the program viewing charge (for example, Japanese Patent Application Laid-Open Ser. No. 2001-54088).

There has also been proposed a technique to acquire and to analyze CM viewing information via a television monitor. The technique adopts a decoder coupled with a recording module and a television monitor of each user who views commercial article or item information broadcast programs on a television monitor. The recording module includes a CM viewing data record section to accumulatively record viewing data of commercial messages for each product of a company sponsoring the advertisement. Using an award associated with the commercial viewing data accumulated on his or her recording module, the user can purchase products of the company. Orders of purchase from each viewer are collected for each product and are sent to the company. It is therefore possible for the company to recognize the correlation between the results of CM viewing and the demands for articles (for example, Japanese Patent Application Laid-Open Ser. No. 9-163351).

However, the techniques described above involve problems as below.

First, since a time in which advertisements are broadcasted is measured, the advertisement viewing time obtained as a result of the measurement does not necessarily indicate the time period during which a user has actually viewed the advertisements.

Second, the user can collect the advertisements in a desired storage device. This allows the user to leave his or her seat or to conduct other activities during the advertisements. As a result, the user is likely to avoid viewing advertisements.

Third, though sponsors pay for programs that will be viewed by those to whom the sponsors are aiming to show advertisements, if the advertisement inserting positions are selected based on the purpose or intention of a user, the intension or desire of the sponsors cannot be reflected. Furthermore, the advertisement charge cannot be simply determined in the conventional way. That is, the charge is conventionally determined according to the time zone and the viewing rate of the program in which the advertisement is to be inserted. There hence arises a problem: it is not guaranteed that the commercial messages of all sponsors are equally viewed by users.

Fourth, though the information of advertisement viewing time to reduce the pay program charge is sent to the broadcast company, a pay program seller in the system, the broadcast company must manage a large amount of information concerning a large number of viewers and determine the amount to be billed according to the viewing time for each viewer. Resultantly, a large amount of load is imposed upon the broadcast company.

### SUMMARY OF THE INVENTION

It is therefore an objective of the present embodiments to provide a technique of enhancing the effect of advertisements by encouraging users to view advertisements.

To solve the problems in accordance with the present embodiments, there is provided an advertisement viewing confirmation system including a broadcast receiver terminal for receiving a broadcast program with advertisement identification (ID) information inserted therein, outputting the program, and transmitting the advertisement ID information through proximity communication, and an advertisement viewing confirmation terminal for receiving, if it is determined based on a temperature that a user is carrying the confirmation terminal, the advertisement ID information through the proximity communication and then creating viewing information by adding user information to the advertisement ID information. The confirmation terminal confirms, according to the viewing information, that the broadcast program with the advertisement ID information inserted therein has been viewed by the user.

Also, in accordance with the present embodiments, there is provided a broadcast receiver terminal for receiving a broadcast program with advertisement identification ID information inserted therein, outputting the program, and transmitting to an advertisement viewing confirmation terminal the advertisement ID information through proximity communication.

Additionally, there is provided an advertisement viewing confirmation terminal for receiving, if it is determined that a user is carrying the confirmation terminal based on a temperature, a broadcast program with advertisement ID information inserted therein, outputting the program, and creating viewing information by adding user information to the advertisement ID information after receiving the advertisement ID information through proximity communication from a broadcast receiver terminal. The confirmation terminal confirms, according to the viewing information, that the broadcast program with the advertisement ID information inserted therein has been viewed by the user.

In accordance with the present embodiments, there is further provided an advertisement viewing confirmation method including the steps of receiving by a broadcast receiver terminal a broadcast program with advertisement ID information inserted therein, outputting the program, and transmitting the advertisement ID information through proximity communication. The method further includes the steps of receiving by an advertisement viewing confirmation terminal, if it is determined that a user is carrying the confirmation terminal based on a temperature, the advertisement ID information through proximity communication and then creating viewing information by adding user information to the advertisement ID information, and confirming by the confirmation terminal, according to the viewing information, that the broadcast program with the advertisement ID information inserted therein has been viewed by the user.

In accordance with the present invention, it is possible to enhance the advertising effect of advertisements by urging the user to positively view the advertisements.

### BRIEF DESCRIPTION OF THE DRAWINGS

The objectives and features of the present invention will become more apparent from the consideration of the following detailed description taken in conjunction with the accompanying drawings in which:

FIG. 1 is a schematic block diagram showing a configuration of an advertisement viewing confirmation system in a first embodiment;

FIG. 2 is a block diagram showing a configuration of a viewing information management terminal 1 in the first embodiment;

FIG. 3 is a block diagram showing structure of a broadcast program transmitting unit 2 in the first embodiment;

FIG. 4 is a block diagram showing construction of a broadcast program receiving unit 3 in the first embodiment;

FIG. 5 is a block diagram showing a configuration of an advertisement viewing confirmation terminal 4 in the first embodiment;

FIG. 6 is a diagram showing a layout of a gained point information table in the first embodiment;

FIG. 7 is a diagram showing a layout of a user information table in the first embodiment;

FIG. 8 is a diagram showing a layout of a sponsor information table in the first embodiment;

FIG. 9 is a diagram showing a layout of an advertisement information table in the first embodiment;

FIG. 10 is a diagram showing a layout of advertisement ID information in the first embodiment;

FIG. 11 is a diagram showing a layout of viewing information in the first embodiment;

FIG. 12 is a diagram showing superimposition of content identifying information onto an advertisement in the first embodiment;

FIG. 13 is a diagram showing structure of a sponsor terminal 5 in the first embodiment;

FIG. 14 is a flowchart showing operation from a user's viewing an advertisement until the advertisement ID information is accumulated in the advertisement viewing confirmation terminal 4 of the first embodiment;

FIG. 15 is a flowchart showing operation from when the gained point information of the user is updated by transmitting the advertisement ID information until an award is obtainable according to the points thus gained and a notification of the condition is received in the first embodiment;

FIG. 16 is a flowchart showing operation in which the advertisement viewing confirmation terminal 4 acquires the gained point information from the viewing information management terminal 1 in the first embodiment;

FIG. 17 is a flowchart showing operation in which when the gained point information of a particular user is acquired and an award is provided to the user, the gained point information of the user is updated in the first embodiment;

FIG. 18 is a block diagram showing a configuration of an advertisement viewing confirmation system in a second embodiment; and

FIG. 19 is a block diagram showing a configuration of a broadcast program receiving unit b 6 in the second embodiment.

### DESCRIPTION OF THE EMBODIMENTS

Referring next to the drawings, description will be given in detail of a first embodiment.

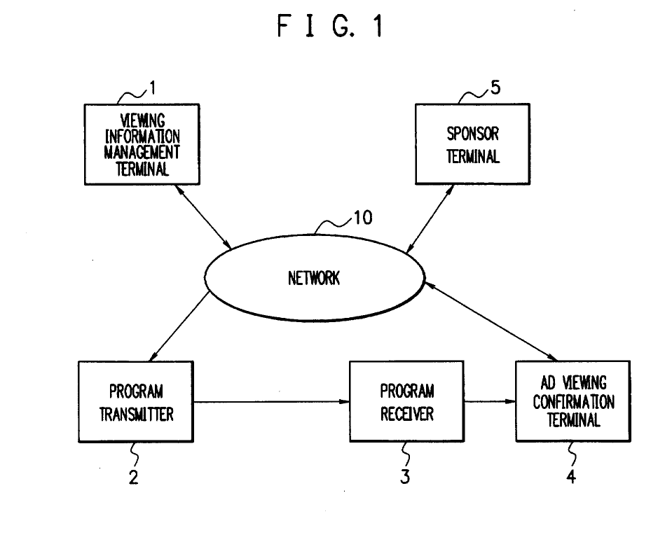

Referring to FIG. 1, an advertisement viewing confirmation system includes a viewing information management terminal 1, a broadcast program transmitter module 2, a broadcast program receiver module 3, an advertisement viewing confirmation terminal 4, and a sponsor terminal 5. The management terminal 1, the transmitter 2, the confirmation terminal 4, and the sponsor terminal 5 are connected via a network 10 to each other.

An operation of the management terminal 1 will be described. The terminal 1 receives advertisement viewing information sent from the terminal 4 to make a check for a reproduction and a forgery of the information. If it is determined that the information has been neither reproduced nor forged, the terminal 1 updates a gained point information table recorded in an information recorder, based on the advertisement viewing information. The table stores, for each user, gained point information of points gained by viewing advertisements. In the operation, the terminal 1 compares a threshold value point, which is determined beforehand, for example, according to a request from a sponsor, with the gained points attained by the user for the advertisement of the sponsor. If the gained points are more than the threshold value point, the terminal 1 notifies the terminal 4 that an award is presented.

When a request for gained point information is received from the terminal 4, the terminal 1 transmits to the terminal 4 the gained point information that represents gained points given for the advertisement viewed by the user.

If a request for personal information is received from the terminal 5, the management terminal 1 sends to the terminal 5 personal information recorded in the information recorder. In this situation, the personal information sent to the terminal 5 is information regarding only the user having the gained points by viewing advertisements of the pertinent sponsor. Moreover, the information is sent only if the user information is beforehand allowed for the sponsor. The personal information can be a useful tool for the sponsor to promote a marketing of products.

The terminal 1 also transmits to the module 2 information required to produce advertisement identifying (ID) information, information to identify an advertisement. The information required to generate advertisement ID information may be a sponsor ID to identify a sponsor, an advertisement ID to identify an advertisement, additional points which can be gained by viewing the associated advertisement, and the like. These information items are beforehand determined and are stored in the information recorder. At creation of the advertisement ID information by the module 2, a digital signature is added to the information to prevent forgery of the information. In this situation, key data necessary for the operation is also delivered via the network 10 to the module 2. Since the key data is a public key, even if the key is stolen by a third party, there is no problem. A private key corresponding to the public key is kept in the terminal 1. For safety, the public and private keys are periodically changed and the public key is sent to the module 2 every time the keys are changed.

Before exchanging data such as advertisement viewing information with the terminal 4, the terminal 1 authenticates the terminal 4 or the user thereof (it is assumed hereinafter that a user authentication is conducted using a user ID). The authentication is similarly accomplished when personal information is sent from the terminal 5. In this situation, after the authentication processing is finished, the communication between the terminal 1 and the terminal 4, and between the terminal 1 and the terminal 5 is desirably carried out using, for example, Secure Socket Layer (SSL) protocol which belongs to the general communication encryption technique.

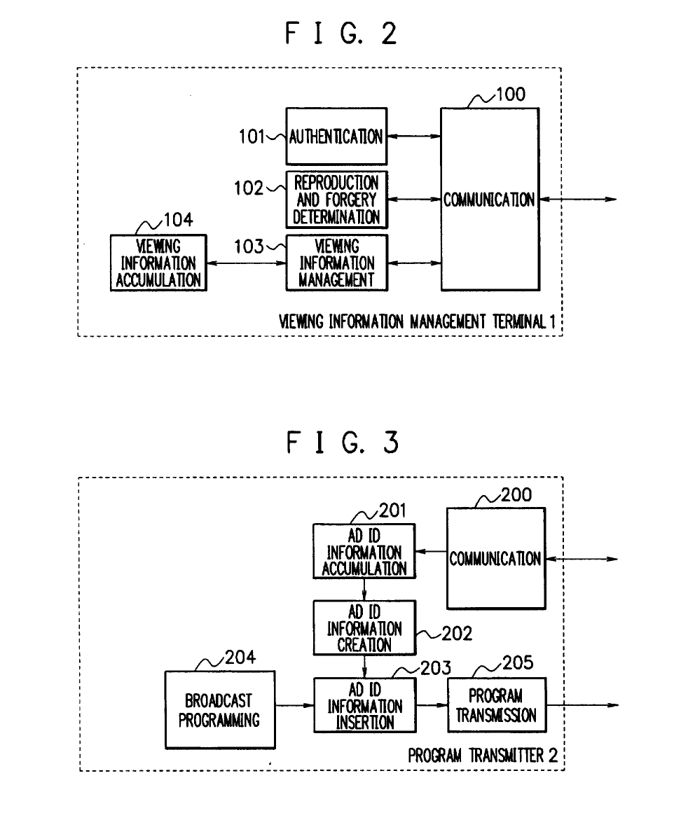

The terminal 1 is an information processing module such as a personal computer and includes, to conduct the operations described above, a communication module 100, an authentication module 101, a reproduction and forgery determination module 102, a viewing information management module 103, and a viewing information accumulation module 104 as shown in FIG. 2.

The module 100 has a function to communicate via the network 100 with other terminals such as the terminal 4 and the broadcast program transmitter 2.

The module 101 keeps authentication information and has a function to execute authentication processing before conducting communication with the terminal 4 or the terminal 5.

The module 102 has a function to determine whether the advertisement viewing information sent from the terminal 4 has been reproduced or forged. A public key to create a signature that is used to detect a forgery is periodically fed to the transmitter 2. A private key corresponding to the public key is kept in the terminal 1 (for example, in the module 102) to detect a forgery using the signature.

The module 103 has a function to retrieve, to read, and to update a particular entry in a gained point information table, a user information table, a sponsor information table, and an advertisement information table, based on the advertisement viewing information inputted thereto.

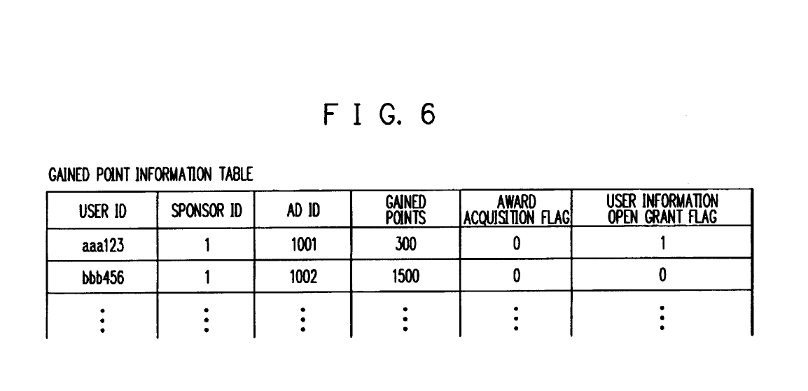

The gained point information table is, for example, a table in the form shown in FIG. 6. In the table, “user ID”, “sponsor ID”, and “advertisement ID” are identifiers to respectively identify a user, a sponsor, and an advertisement. An identifier may be a string of alphanumeric characters with sufficient length. The term “gained points” indicate the total of points gained that the user identified by the user ID has gained by viewing the advertisement associated with the advertisement ID of the sponsor identified by the sponsor ID. The term “award acquisition flag” is used to record that the user has already obtained an award. The term “user information grant flag” is a flag indicating whether personal information items such as an age or a gender that has been beforehand registered by the user can be disclosed to the sponsor. In the description below, the user gains larger points by opening such personal information items to the sponsor.

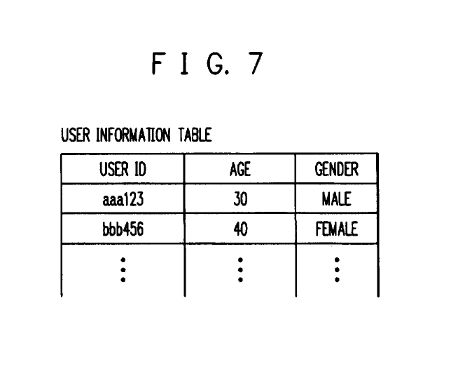

The user information table is a table to record personal information regarding users. The personal information is opened to the sponsor if the “user information grant flag” of the gained point information table is set to a value (for example, one) indicating that the access is allowed. Like the gained point information table, the user information table is recorded in the module 104, for example, in the format shown in FIG. 7. In FIG. 7, “user ID” is an identifier to uniquely identify a user and corresponds to “user ID” of the gained point information table. “Age” indicates the age of a user. This item may indicate the exact age or may indicates an age group, for example, the twenties or the thirties. “Gender” indicates the gender of a user. The user information table may include items other than those shown in FIG. 7.

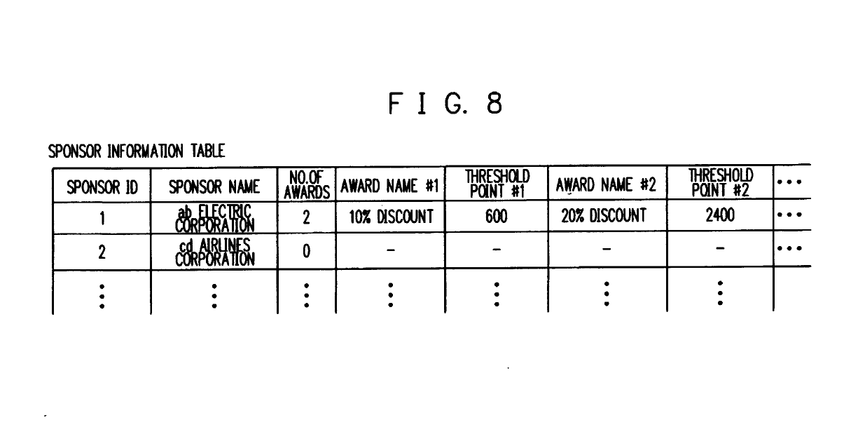

The sponsor information table is a table including description of information of sponsors and information of awards that a user can obtain by viewing advertisements of a sponsor. The table is, for example, in the format shown in FIG. 8. In the sponsor information table, “sponsor ID” is an identifier to uniquely identify a sponsor and corresponds to the “sponsor ID” of the gained point information table. “Sponsor name” is the name of a sponsor desiring or requesting the advertisement and “number of awards” indicates the number of types of awards that a user can obtain based on the gained points. “Award #n” and “threshold point #n” respectively indicate the name of an award obtained by a user and points that a user needs to obtain by viewing the advertisements of a sponsor to acquire an award. Columns of “award #n” and “threshold point #n” are entered as many as the types of awards indicated by “number of awards”.

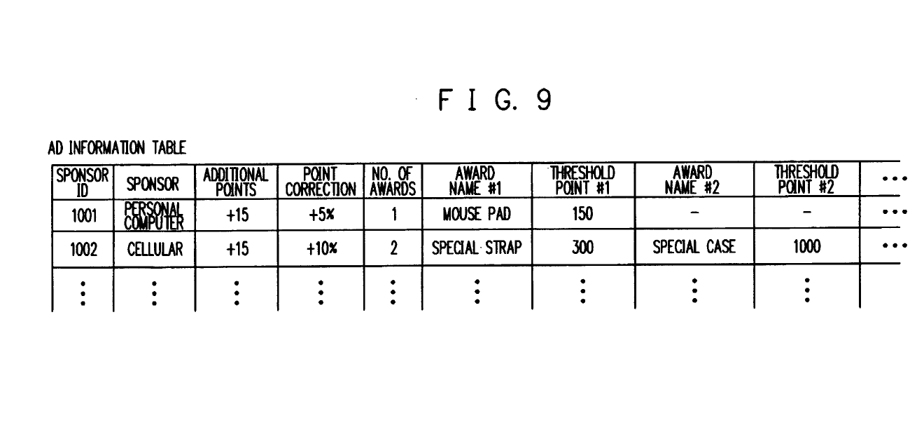

The advertisement information table is a table including description of information of advertisements and information of awards that a user can gain by viewing the advertisements. The table is in the format shown in FIG. 9. In the table, “advertisement ID” is an identifier to uniquely identify an advertisement and corresponds to the “advertisement ID” of the gained point information table. “Advertisement name” is a name capable of identifying an advertisement such as a title associated with the advertisement and “additional points” indicate points that a user can obtain by viewing the advertisement. “Point correction value” indicates a point correction value if “user information grant flag” of the point information table contains the value to grant a disclosure, for example, “one”. The point correction value may be in terms of percent such as +5%. “Number of awards” is the number of types of awards that a user can obtain based on the gained points. “Award #n” and “threshold value #n” respectively represent the name of an award obtained by a user and points that a user needs to obtain by viewing the advertisements of a sponsor to acquire the award. Columns of “Award #n” and “threshold value #n” are entered as many as the types of awards indicated by “number of awards”.

Of the constituent components of the terminal 1, the module 100 includes communication hardware such as an ethercard and software to control the hardware. The module 101, the module 102, and the module 103 are implemented using software and/or hardware such as a Large Scale Integration (LSI) device. The module 104 may be realized by use of a recording device including a hard disk, an optical disk medium, and a disk drive. However, the configuration is only an example, and hence other constituent components may also be employed.

Next, an operation of the transmitter 2 will be described. The transmitter 2 accumulates broadcast programs and advertisements from sponsors, and transmits, according to a program broadcast schedule prepared beforehand, a broadcast program with advertisements inserted therein. In the operation, the transmitter 2 creates advertisement ID information according to the advertisement information received from the terminal 1 and then broadcasts the information at timing synchronized with the advertisements placed in the program.

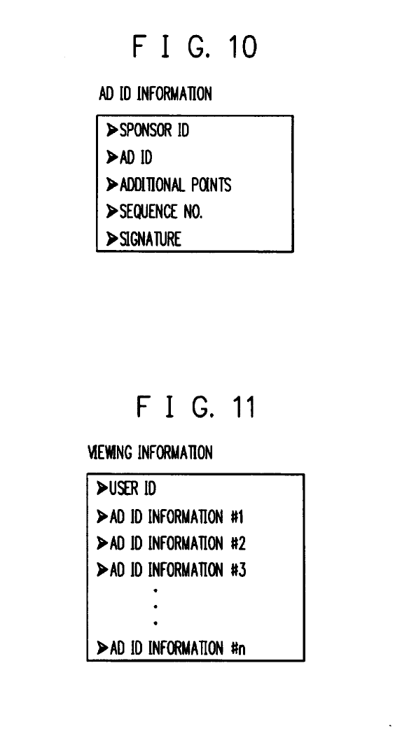

The advertisement ID information is configured, for example, as shown in FIG. 10. In the information, “sponsor ID” and “advertisement ID” are identifiers to respectively identify a sponsor associated with the advertisement ID information and an advertisement corresponding to the sponsor. “Additional points” indicate points that a user can obtain by viewing the advertisement. “Sponsor ID”, “advertisement ID”, and “Additional points” are obtained as below. That is, the information items are read out from the sponsor information table and the advertisement information table stored in the module 104 of the terminal 1 and are then delivered to the transmitter 2. “Sequence number” is a value that is incremented each time the transmitter 2 sends advertisement ID information, and is disposed to determine whether the advertisement ID information is a reproduction. “Signature” is produced as follows. The advertisement ID information items other than “signature” are converted by use of a hash function such as “Message Digest 5 (MD5)” into a digest value. The digest value is encrypted using a public key fed from the terminal 1 into a signature. With the “signature”, it is possible to determine in the terminal 1 whether the contents of the advertisement ID information have been forged.

For example, in the digital broadcast, the transmitter 2 transmits the advertisement ID information at timing synchronized with video and audio signals of the advertisement in a method using Packetized Elementary Stream (PES) prescribed by MPEG. There may also be employed a method in which the advertisement ID information is stored in a private stream capable of storing any data other than video and audio information to be multiplexed with other data items such as video and audio data items. On the other side, in the analog broadcast, it is possible to adopt a method in which as in the character broadcast and the data multiplexed broadcast the advertisement ID information is superimposed onto the Vertical Blanking Interval (VBI), a blanking zone between screens. However, these operations in the digital broadcast and the analog broadcast are only examples. That is, other methods may also be utilized to insert the advertisement ID information in broadcast programs.

The broadcast program from the transmitter 2 is transmitted via radio waves where air is a communication medium or via electric signals where an electric wire or a cable is a communication medium. Also, the broadcast program may be sent via optical signals using an optical fiber.

The transmitter 2 includes a plurality of hardware units and a plurality of software modules. To achieve the function described above, the transmitter 2 includes a communication module 200, an advertisement ID information accumulation module 201, an advertisement ID information creation module 202, an advertisement ID information insertion module 203, a broadcast programming module 204, and a program transmission module 205 as shown in FIG. 3.

The module 200 has a function to communicate via the network 10 with other terminals such as the terminal 1.

The module 201 has a function to accumulate information that is sent from the terminal 1 to construct advertisement ID information. The information items to configure the advertisement ID information include, for example, a sponsor ID, an advertisement ID, additional points, and a public key to create a signature.

The module 202 has a function to create, based on the information stored in the module 201, advertisement ID information to be inserted in an advertisement position of an associated broadcast program.

The module 203 has a function to insert the advertisement ID information created by the module 202 in the advertisement position with synchronization established therebetween. The information may be inserted according to a method in which the information is stored in a private stream for the digital broadcast or a method in which the information is superimposed onto the VBI for the analog broadcast.

The module 204 has a function to arrange, according to program arranging information, program contents and advertisement contents accumulated in advance to thereby prepare a program schedule for broadcast (a broadcast program).

The module 205 has a function to transmit a broadcast program with the advertisement ID information inserted therein by use of, for example, radio waves, electric signals, or optical signals, through air, a cable, or an optical fiber, respectively. However, the transmission medium is not restricted by this example, that is, other transmission media may also be adopted.

The module 200, the module 203, and the module 204 are implemented using, for example, hardware and software to control the hardware. The module 201 may be realized by use of a recording device including a hard disk, an optical disk medium, or a drive. The module 202 may be implemented using software or an LSI unit. However, these configurations are only examples, and hence other configurations may also be employed.

Description will now be given of an operation of the broadcast program receiver 3. The receiver 3 receives a broadcast program sent via a communication medium such as air, an electric wire, or an optical fiber from the transmitter 2 to extract a broadcast program of a channel designated in advance. If advertisement ID information is detected in advertisements inserted in the program, the receiver 3 obtains the information therefrom to deliver the information to the terminal 4. In the transmission of the advertisement ID information to the terminal 4, since it is highly likely that a user is listening to advertisements associated with the advertisement ID information if the terminal 4 is in the proximity of the receiver 3, it is more suitable to use a communication method with a narrow communicable range such as the method of Bluetooth and a method adopting an infrared ray. The advertisement from which the advertisement ID information has been removed is fed to the video and audio output unit to present the video and audio advertisement to a user.

The receiver 3 has a function, if necessary, to record a broadcast program in a program recording unit. The broadcast program is recorded in a format including the advertisement ID information associated therewith. Specifically, in the digital broadcast, the received program is, for example, recorded together with the video and audio data without modification. However, in a case of the analog broadcast in which the program is directly recorded, for example, on videotape without modification, the information superimposed onto the VBI is not lost. Therefore, the program is directly recorded on the videotape. In a situation in which the program is encoded, for example, according to the MPEG system into digital data to be recorded on an HDD, a Versatile Video Disk (DVD), a recording tape, or the like, only the data of the display screen is encoded and the information superimposed onto the VBI is lost. Therefore, the advertisement ID information is read out from the VBI to be recorded on the program recording unit with a correspondence established between the information and the encoded video and audio data of the broadcast program. To reproduce the broadcast program recorded as above, the advertisement ID information is sent to the terminal 4 as in the processing of the broadcast program received from the transmitter 3.

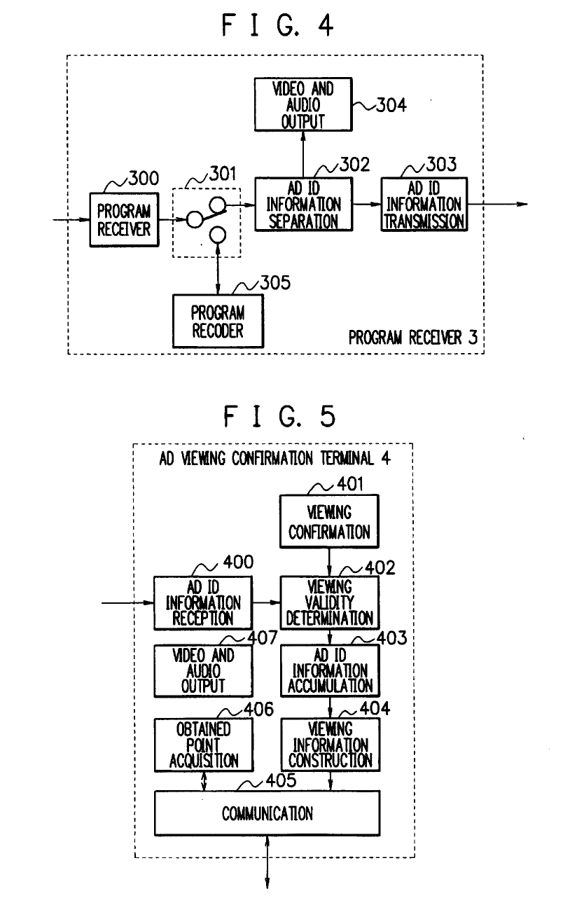

It is assumed that the receiver 3 may be realized by hardware such as a set-top box. However, the receiver 3 may be realized by software that runs on a personal computer including an interface and a recorder required for the above operation. To implement the function, the receiver 3 further includes a program receiving module 300, a signal selecting module 301, an advertisement ID information separating module 302, an advertisement ID information transmitting module 303, a video and audio output module 304, and a broadcast program recorder 305 as shown in FIG. 4.

The module 300 has a function to receive a broadcast program fed from the transmitter 2. Since the program is delivered using, for example, an electric wave, an electric signal, or an optical signal, the module 300 includes an interface capable of receiving such signals or a plural types of signals. In addition, the module 300 has a function to extract, from broadcast programs that are contained in the received signal and that are sent from a plurality of broadcasting companies, a program of the broadcasting company designated by a user. It is assumed in this embodiment that a user designates a broadcast program delivered from the transmitting unit exemplified by the transmitter 2.

The module 301 has a function to deliver a broadcast program selectively extracted by the module 300 to either one or both of the module 302 and the unit 305. The module 301 also has a function to output to the module 302 a broadcast program stored in the recorder 305.

The module 302 has a function to obtain from a broadcast program where the advertisement ID information was inserted to synchronize with the advertisement, and to send the information to the module 303. The module 302 delivers to the module 304 the broadcast program from which the advertisement ID information has been removed.

The module 303 has a function to transmit the advertisement ID information by a communication device with a narrow communication range or high directivity such as Bluetooth or a communication method employing an infrared ray in order to limit the range in which the advertisement ID information can be received to the neighborhood of the receiver 3.

The module 304 has a function to present a broadcast program in the form of video, audio, and character information.

The recorder 305 has a function to record, when a broadcast program is received, the program where synchronization between the advertisement ID information and the advertisement is kept using the method described above.

In the configuration, it is possible to construct the module 300, the module 301, and the module 303 by use of hardware and software to control the hardware. The module 302 may be implemented using software. The recorder 305 is realizable by using a recorder such as a hard disk, an optical disk, and a disk drive, and software that controls the recorder and that includes a program recording function. The module 304 may be realized by using a Cathode-Ray Tube (CRT), a liquid-crystal display, and/or a speaker. The above configuration is only an example, and hence any other configuration may be employed.

In this embodiment, the receiver 3 is configured including the recorder 305. However, the recorder 305 may be dispensed with. If the receiver 305 is not employed, the module 301 is not required either.

Description will now be given of an operation of the terminal 4. The terminal 4 receives advertisement ID information fed from the receiver 3. If it is determined that a user is viewing the associated advertisement since a viewing confirmation button or the like of the terminal 4 is depressed, the terminal 4 accumulates the advertisement ID information. The terminal 4 adds a user ID to the accumulated advertisement ID information and generates viewing information (see FIG. 11) at an occasion such as a user's operation or a lapse of a predetermined period of time, and then delivers the viewing information to the terminal 1. After the information is sent to the terminal 1, if the gained points of the user have reached the value to gain an award, the terminal 1 sends a notification of the gaining of the award and information of the obtained award. The terminal 4 presents the notification and the information in the form of character, video, and/or audio information to the user.

The terminal 4 can also attain from the terminal 1 points obtained so far and award information set by a sponsor to a pertinent advertisement. The terminal 4 then presents these information items using the character, video, and/or audio information.

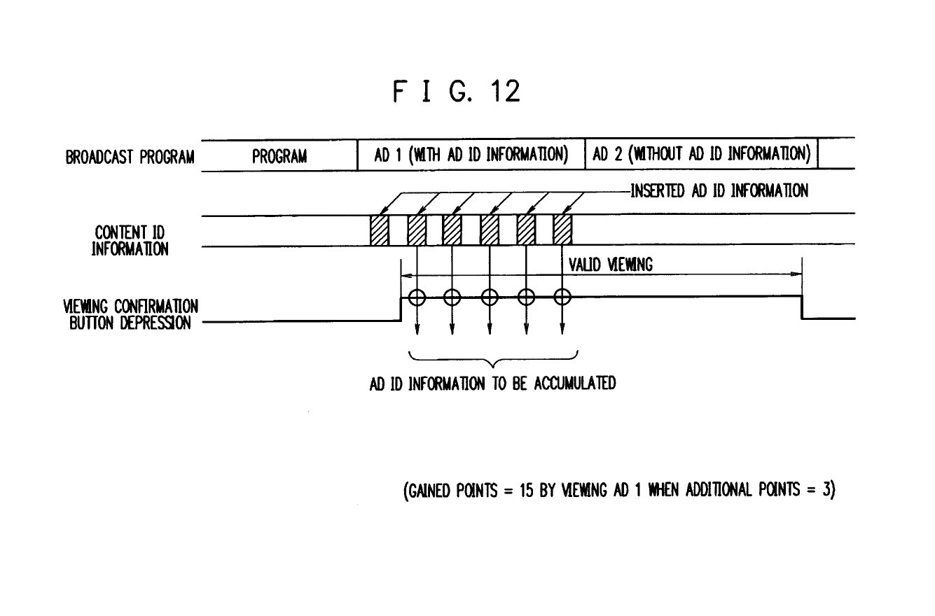

When the receiver 3 delivers the advertisement ID information using a transmission method with a narrow communication range or high directivity, the range in which the terminal 4 can receive the ID information is limited to the neighborhood of the receiver 3. Moreover, the depression of the viewing confirmation button may be added to the condition to receive and to accumulate the advertisement ID information as shown in FIG. 12. In such a case, to receive the ID information, a user must carry the confirmation terminal 4 and go into the vicinity of the terminal 4. This improves accuracy in the judgment of advertisement viewing.

It is also possible to measure the body temperature of a user by a sensor, and determine whether the user carries about the terminal 4, thereby concluding that the user is viewing advertisements. In this operation, the user need not depress buttons. This removes annoyance to push down buttons and lighten the load imposed on the user.

The terminal 4 is realized using a small-sized portable computer such as a cellular phone and a Personal Digital Assistance (PDA). To implement the functions, the terminal 4 includes an advertisement ID information receiving module 400, a viewing confirming module 401, a viewing validity determination module 402, an advertisement ID information accumulation module 403, a viewing information constructing or arranging module 404, a communication module 405, a gained point acquiring module 406, and a video and audio output module 407 as shown in FIG. 5.

The module 400 has a function to receive advertisement ID information sent from the receiver 3.

The module 401 has a function to determine that the user carries about the terminal 4, for example, according to the depression of a viewing confirmation button or the body temperature measurement by a sensor. The module 401 sends a result of the viewing confirmation to the module 402, the result being indicated by, for example, the value of a voltage.

The module 402 delivers the advertisement ID information to the module 403 if the advertisement ID information is received from the module 400 and it is confirmed according to the signal supplied from the module 401 that the user is carrying about the terminal 4.

The module 403 records the advertisement ID information.

The module 404 reads out the advertisement ID information from the module 403 to construct viewing information by adding a user ID to the advertisement ID information.

The module 405 communicates via the network 10 with the terminal 1.

The module 406 obtains, via the module 405 from the terminal 1, information of points that a user has gained by viewing advertisements.

The module 407 presents the point information gained by a user and the award information attained according to the gained points, in the form of video, audio, and/or character information.

The module 400 and the module 405 are realized using hardware and software to control the hardware. It is possible to construct the module 401 by use of hardware such as buttons or temperature sensors to determine whether a user is carrying about the terminal 4, and software to process a signal received from buttons or temperature sensors. The module 402, the module 404, and the module 406 may be realized by software. The module 403 may also be realized using a recording device, for example, a hard disk or a flash memory. The module 407 is realized by using a CRT, a liquid-crystal display, and a speaker. These configurations are only examples. Other constituent components may be used.

Next, an operation of the terminal 5 is described. The terminal 5 has a function to obtain, via the network 10 from the terminal 1, points of each user having gained the points by viewing advertisements associated with the sponsor. Therefore, when a user buys an article of a sponsor, if the user notifies the sponsor of his or her user ID, the sponsor recognizes the gained points and an award corresponding to the points to thereby provide the award to the user.

If the terminal 4 displays information of points obtained by a user in a form that prevents forgery of the point information by adopting an encryption technique or the QR code, the user may acquire an award from a sponsor by showing the terminal 4 to the sponsor.

If “user information grant flag” of the gained point information table shown in FIG. 6 is set to the value indicating disclosure of user information, the terminal 5 can acquire from the terminal 1 the personal information associated with the advertisement such as the age and the gender of the user. The sponsor can utilize the information for the marketing of articles.

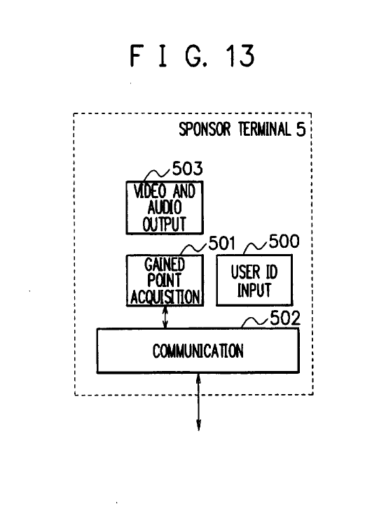

The terminal 5 is realized using, for example, a personal computer. As shown in FIG. 13, the terminal 5 further includes a user ID input module 500, a gained point acquisition module 501, a communication module 502, and a video and audio output module 503.

The module 500 has a function to input a user ID of a user who receives an award. A user ID which user notifies by voice is supplied via an interface such as a keyboard or the user ID may be inputted via an electric wave, an infrared, or the network 10 from the terminal 4 that the user is carrying about.

The module 501 includes a function to acquire the user's gained points via the network 10 from the terminal 1 by employing the user ID attained from the module 500. The module 501 further has a function to obtain the award information of the user from the terminal 1. The module 501 is realized using, for example, software.

The module 502 has a function to communicate via the network 10 with the terminal 1 and the like. The module 502 is configurable by use of, for example, communication hardware such as an ethercard and software to control the hardware.

The module 503 has a function to present the information of points gained by a user and information of an award attained by the user according to the gained points, in the form of video, audio, and character information. The module 503 is realized by using a CRT, a liquid-crystal display, and/or a speaker.

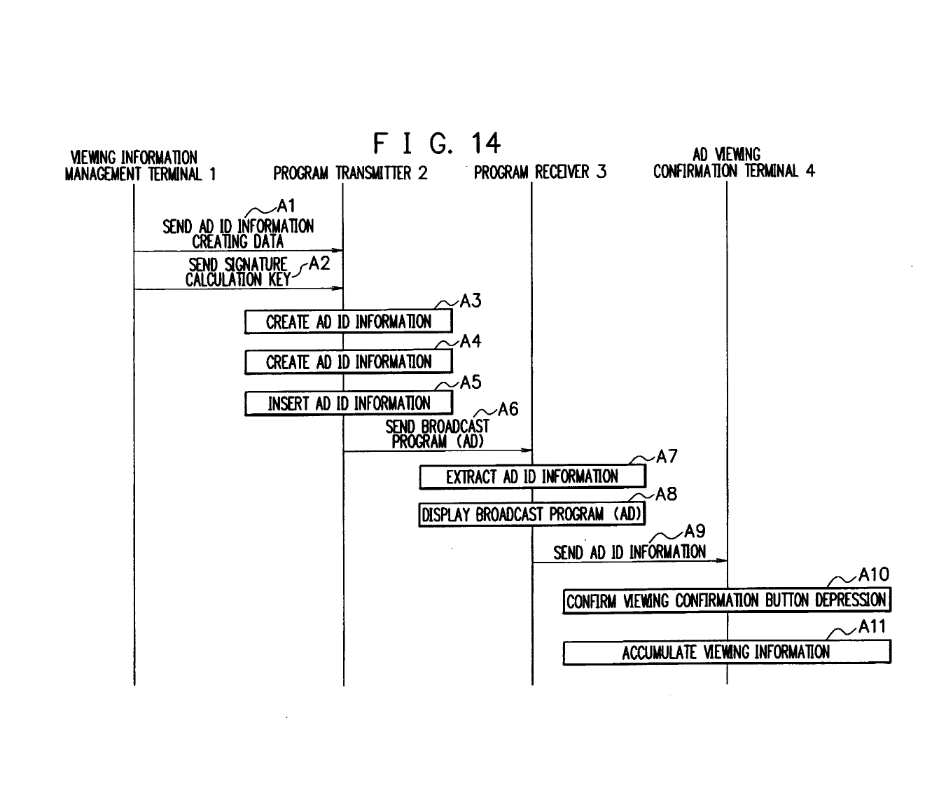

Referring next to the flowcharts shown in FIGS. 14 to 17, description will be given of an operation of this embodiment.

First, referring to FIG. 14, description will be given of a processing flow in which the user views an advertisement and the advertisement ID information is accumulated in the terminal 4.

The terminal 1 reads out a sponsor name and a sponsor ID (the identifier of the sponsor) from the sponsor information table stored in the module 104, and also reads out an advertisement name, an advertisement ID (the identifier of the advertisement), as well as additional points from the advertisement information table. The terminal 1 then feeds the obtained information items to the transmitter 2 (step A1). It is also possible to transmit other information items.

Next, the terminal 1 sends to the transmitter 2 a public key required to create a signature of the advertisement ID information (step A2). It is assumed to transmit the sponsor name and the advertisement information as well as the public key via the network 10 to the transmitter 2. However, the information items may be sent, for example, using a physical communication method such as by mail.

The transmitter 2 then accumulates the sponsor and advertisement information items, and the public key information for creating advertisement ID information in the module 201 (step A3).

In the broadcasting of the advertisement, if the data that have been accumulated in the module 201 and are used for creating advertisement ID information includes data corresponding to the pertinent advertisement (this is determined by checking the correspondence therebetween using, for example, the sponsor name), the transmitter 2 generates advertisement ID information from signatures, the data for creating the advertisement ID information (a sponsor ID, an advertisement ID, and additional points), and sequence numbers that are incremented each time advertisement ID information having the same sponsor ID and the advertisement ID is produced (step A4). A signature is attained as below. The advertisement ID information data other than a signature is generated according to, for example, MD5 to obtain a digest value. The digest value is then encrypted using the public key fed from the terminal 1 to resultantly obtain a signature.

The transmitter 2 then inserts the advertisement ID information generated as above in the broadcast program such that the information synchronizes with the image and sound of the associated advertisement (step A5). As already described above, the advertisement ID information is stored in the private stream to be multiplexed for transmission in the digital broadcast. In the analog broadcast, the data of the advertisement ID information is superimposed onto the VBI. By adding information, which indicates that an award is obtainable by viewing an advertisement, to either one or both of images and sounds of an advertisement with the advertisement ID information inserted therein, it is possible to notify a user of the existence of the advertisement ID information.

The transmitter 2 then transmits the broadcast program in which the advertisement ID information is inserted (step A6).

The receiver 3 then receives the broadcast program sent from the transmitter 2. If the advertisement ID information is detected in the program, the receiver 3 extracts the information therefrom (step A7).

Subsequently, the receiver 3 presents the advertisement in the information by using the module 304 (step A8).

The receiver 3 delivers the advertisement ID information to the terminal 4 (step A9).

On reception of the information from the receiver 3, the terminal 4 confirms whether the user has depressed a viewing confirmation button (step A10). If the button has been depressed, the terminal 4 accumulates the advertisement ID information (step A11). In this connection, if it is assumed that the button is being depressed, the operational load imposed on the user is reduced although an advertisement viewing condition become loose. If there is employed a method other than the method using the depression of the button, that is, if the terminal 4 includes a temperature sensor to determine whether a user is carrying about the terminal 4 according to the body temperature measured by the sensor, the user's load is reduced without loosening a advertisement viewing condition.

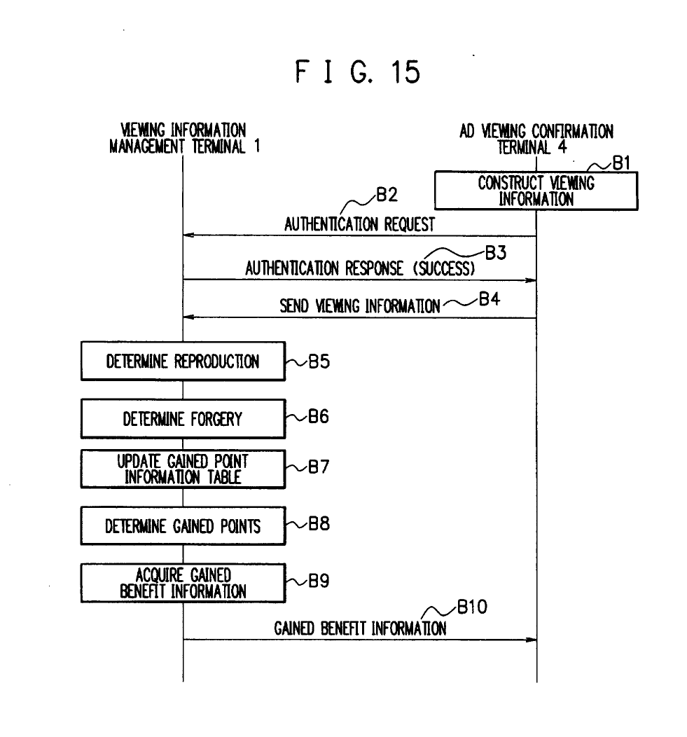

Referring now to FIG. 15, description will be given of a processing flow in which the terminal 4 delivers the advertisement ID information to the terminal 1, the gained point information of a user is updated, and the gained points allow the user to attain an award. It is assumed that the communication sequence between the terminal 4 and the terminal 1 is carried out via the network 10.

At an event of pushing down a viewing information transmission button by the user of the terminal 4, or an equivalent event such as selection of a menu or a lapse of a predetermined period of time, the terminal 4 constructs viewing information by adding a user ID to the accumulated advertisement ID information (step B1).

Employing a user ID and a password beforehand assigned to the user, the terminal 4 issues an authentication request to the terminal 1 (step B2).

When a response of “successful authentication” is received from the terminal 1 (step B3), the terminal 4 feeds the viewing information to the terminal 1 (step B4). If the authentication fails, the processing is immediately terminated.

The terminal 1 extracts the advertisement ID information from the viewing information. To determine whether the advertisement ID information has been copied, the management terminal 1 checks whether the sequence number of the advertisement ID information is duplicated for the same user ID and the same advertisement ID (step B5).

The digest value obtained by decrypting the signature in the advertisement ID information by use of a private key corresponding to the public key employed to create the signature is compared with the digest value calculated by the terminal 1 according to the advertisement ID information. Depending on whether these digest values match each other, it is determined whether the information has been forged (step B6). At creation of the digest value, it is required for the terminal 1 to utilize the digest function employed by the transmitter 2.

The terminal 1 searches the gained point information table in the module 104 using as a search key the user ID, the sponsor ID and the advertisement ID in the advertisement ID information. If such an entry is detected, the terminal 1 creates the contents of the entry. Otherwise, the terminal 1 produces a new entry. The terminal 1 then adds the additional points to the gained points of the entry (step B7). For example, if the user ID is “aaa123”, the sponsor ID is “1”, the advertisement ID is “1001”, and the additional points are “+15”, the entry of the first row of FIG. 6 is retrieved and the gained points are updated to “315”.

The gained points thus updated are compared with one or more threshold value points set respectively to the sponsor information table and the advertisement information table to determine whether an award should be given by the gained points at the present time. In the operation, if the user information grant flag is “1” (the disclosure is granted) in the gained point information table, the comparison is carried out using the corrected gained points (the gained point values are kept unchanged in the table) according to the settings of point correction items in the advertisement information table to determine whether the gained points reach the threshold value points to obtain an award (step B8).

If it is determined that the user has attained the award, the terminal 1 reads out the sponsor name, the advertisement name, and the award name from the sponsor information table and the advertisement information table (step B9) and then transmits the information items to the terminal 4 (step B10).

The item of the user information grant flag may be set in the gained point information table as below. If the terminal 4 receives a pair of the sponsor ID and the advertisement ID for the first time, the terminal 4 urges the user to decide whether the personal information is disclosed to a sponsor. When the user decides a flag value, the terminal 4 delivers the information to the terminal 1. According to the setting information, the terminal 1 sets the grant flag. Alternatively, the flag may be set as below. The user beforehand determines a sponsor to which the personal information is disclosed and notifies a controller of the terminal 1 of the sponsor in advance. According to the notification, the controller sets the personal information grant flag.

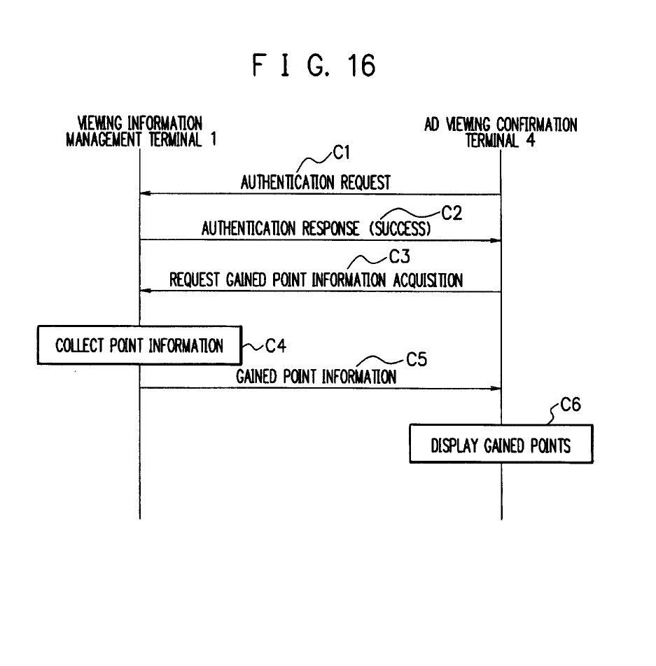

Referring next to FIG. 16, description will be given of a procedure in which the terminal 4 acquires the gained point information from the terminal 1. This procedure enables a user to confirm with the terminal 4 the points gained by viewing advertisements.

At an event of depression of a gained point acquisition button by the user of the terminal 4 or selection of a menu, a gained points information acquisition procedure starts. The terminal 4 issues an authentication request to the terminal 1 by employing a user ID and a password beforehand assigned to the user (step C1).

On receiving a response of “successful authentication” from the terminal 1 (step C2), the terminal 4 delivers a request for the gained point information to the terminal 1 (step C3). The request includes the user ID. If the authentication fails, the process is immediately terminated.

When the request is received, the terminal 1 searches the gained point information table stored in the module 104, using a search key including the user ID of the request, to read out all gained point information items of the user. The terminal 1 also reads out an associated sponsor name from the sponsor information table and an advertisement name associated with the sponsor from the advertisement information table (step C4). If the user information is disclosed, the gained points are corrected according to the point correction item in the advertisement information table.

The terminal 1 sends a set of the sponsor name, the advertisement name, and the gained points (gained point information) to the terminal 4 (step C5).

The gained point information may further include an award name attainable from the advertisement information table and point information (of the threshold points) required to attain the award. In this situation, since the user can recognize the points to be gained to acquire an associated award, the gained point information leads to an advantageous effect to urge the user to view advertisements.

When the gained point information is received, the terminal 4 presents the information in the form of the character, video, and/or audio information to the user (step C6).

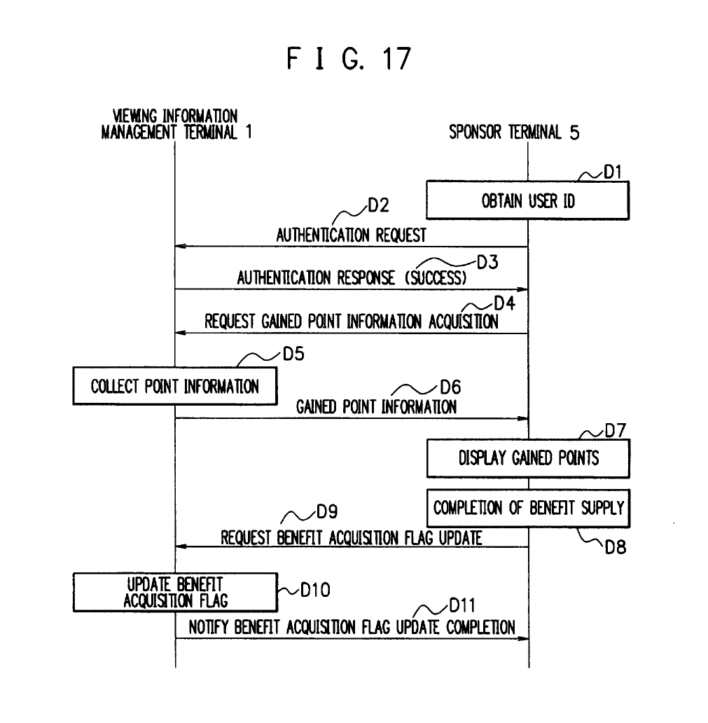

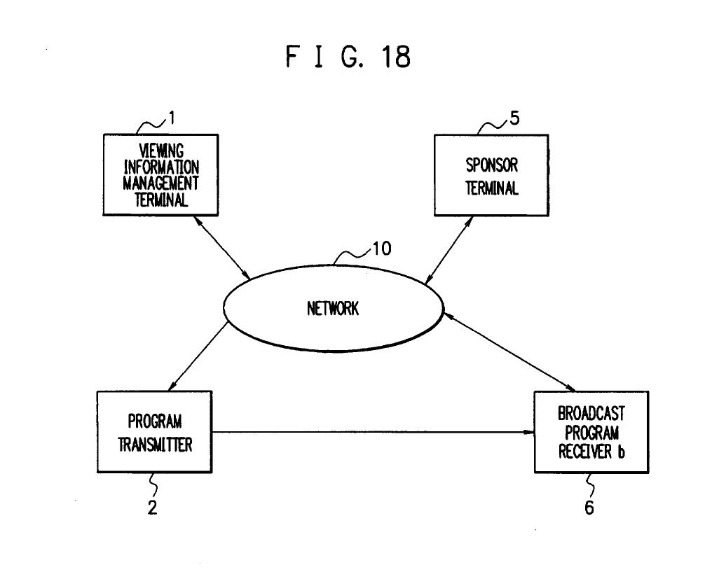

Referring now to FIG. 17, description will be given of an operation in which the terminal 5 attains gained point information of a particular user from the terminal 1 and updates, when an award is provided to the user, the gained point information of the user. Using the operation, the sponsor can confirm the points that the user has gained to provide the user with the award set in advance according to the gained points. The sponsor also can record that an award has been provided to the user.

At an event of depression of a gained point acquisition button of the terminal 5 or selection of a menu, the gained points information acquisition procedure is started.

The terminal 5 attains the user ID from the user desiring the award, orally, via the network, or through transmission via the terminal 4 using an infrared ray or an electric wave (step D1).

The terminal 5 issues an authentication request to the terminal 1 by employing a sponsor ID and a password beforehand assigned to the sponsor (step D2).

On receiving a response of “successful authentication” from the terminal 1 (step D3), the terminal 5 transmits the gained point information acquisition request to the terminal 1 (step D4). The request includes the user ID obtained from the user in step D1 and the sponsor ID and the advertisement ID. If the authentication fails, the processing is terminated.

When the request is received, the terminal 1 makes a search through the gained point information table recorded in the module 104, using a search key including the user ID, the sponsor ID, and the advertisement ID contained in the request, to read out the gained point information from an entry matching with the search key. The terminal 1 also reads out an associated sponsor name from the sponsor information table and an advertisement name associated with the sponsor from the advertisement information table. In addition, the terminal 1 reads the award name and the point information (indicating the threshold value points) required to obtain an award from the advertisement information table (step D5). If the user information is disclosed, the gained points are corrected according to the description of the point correction item in the advertisement information table.

The management table 1 then transmits the information items including the gained points to the terminal 5 (step D6).

When the information including the gained point information is received, the terminal 5 presents the information, including the points and the award that the user gained by viewing advertisements of the sponsor, in the form of the character, video, and/or audio information to the sponsor (step D7). Therefore, the sponsor can confirm the award attained by the user and can provide an award to the user.

After the sponsor supplies an award to the user, the operation to supply the award is completed by, for example, depressing an associated button (step D8). In response thereto, the terminal 5 notifies the terminal 1 of an award acquisition flag update request to thereby record the completion of the award supply (step D9). The request includes the user ID, sponsor ID, the advertisement ID, and the award acquisition flag value.

After having received the flag update request, the terminal 1 searches the gained point information table recorded in the module 104 for an entry by use of a search key including the user ID, the sponsor ID, and the advertisement ID contained in the request. As a result, the terminal 1 updates the award acquisition flag in the obtained entry to the award acquisition flag value of the request (step D10). For example, by updating the flag from “0” to “1”, it is possible to record that the first award has been provided to a user. However, the meaning of the flag is not restricted by this example. Further, if an award is a discount service and the discount award continues, the award acquisition flag may be not used.

The terminal 1 sends the notification of completion of the award acquisition flag update to the sponsor terminal 5 (step D11).

In the description above, although it is assumed that the advertisement ID information is inserted in the advertisement, the information may be inserted in a broadcast program. In such situation, the broadcast company or the sponsor of the broadcast program may provide an award to a user.

In accordance with the embodiment, the system includes the viewing information management terminal 1, the broadcast program transmitter 2, the broadcast program receiver 3, the advertisement viewing confirmation terminal 4, and the sponsor terminal 5 such that the user can gain points by viewing advertisements to resultantly acquire an award from the sponsor according to the gained points. According to the configuration, the sponsor can prompt a user to view advertisements to thereby enhance the sales of advertised articles.

Thanks to the increased advantageous effect of the advertisement as above, it is possible for the broadcast company possessing the transmitter 2 to set a higher price to an advertisement frame in a broadcast program for a sponsor.

Moreover, a manager of the terminal 1 can acquire from a sponsor and a broadcast company a service charge by providing the sponsor with the viewing information of users and by providing the broadcast company with an advertisement ID information creating device.

Additionally, the terminal 1 keeps personal information and a flag that indicates whether a user presents, for each sponsor, the personal information. If the user allows the personal information to be accessed by a sponsor, it is possible to obtain more points from the sponsor. This encourages the user to disclose the personal information. This consequently makes it possible for the sponsor to obtain the personal information such as the age group and the gender of the user. Therefore, the sponsor can reflect the personal information in the marketing of the articles of advertisements to thereby promote the sales of the articles.

Also in the receiver 3, a broadcast program is recorded in the module 305. When reproducing a recorded program, advertisement ID information synchronized with an advertisement is kept unchanged in the synchronized state. In consequence, when the user reproduces the broadcast program using the module 305 to view the program, the user can obtain points by viewing advertisements. It is hence possible to prompt the user to view a broadcast program without skipping advertisements.

When the receiver 3 transmits the advertisement ID information in a narrow communication range or with high directivity, the range in which the terminal 4 can receive the ID information is limited to the proximity of the receiver 3. In addition, by disposing the module 401 to determine whether a user is carrying about the terminal 4, the advertisement viewing can be more correctly judged.

A sequence number and a signature are disposed in the advertisement ID information to judge the viewing information and the terminal 1 includes the module to detect a copy (reproduction) and a forgery of the advertisement ID information. It is possible to ensure reliability of the gained point information of the user.

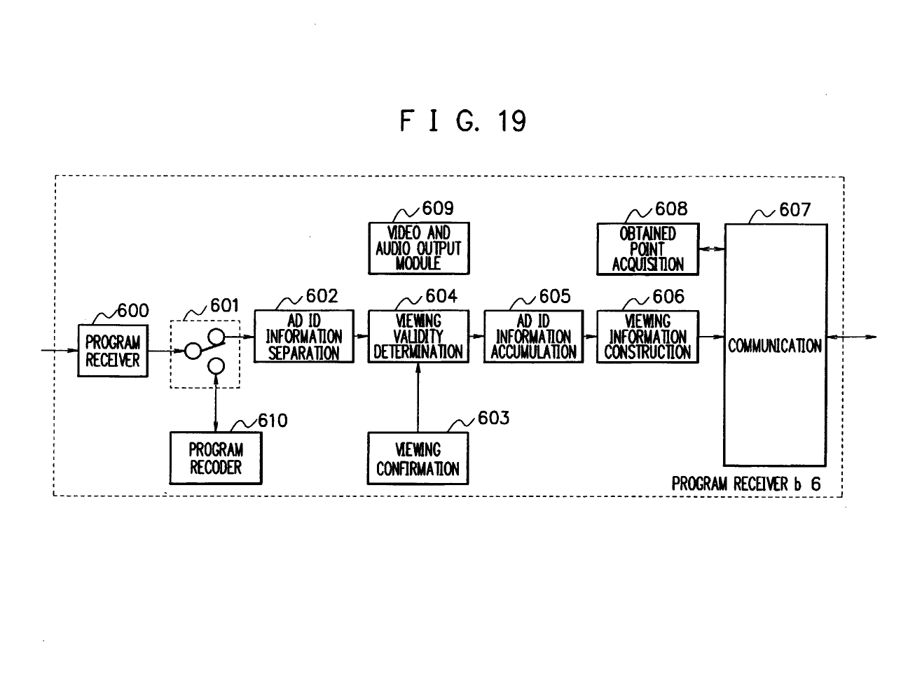

Referring next to FIGS. 18 and 19, description will be given in detail of the configuration of the second embodiment.

As can be seen from FIG. 18, the advertisement viewing confirmation system of the second embodiment includes a viewing information management terminal 1, a broadcast program transmitting device 2, a broadcast program receiver b 6, a sponsor terminal 5, and a network 10.

The terminal 1, the transmitter 2, and the terminal 5 are similar in configuration, function, and operation to the management terminal 1, the program transmitter 2, and the sponsor terminal 5 of the first embodiment. Therefore, duplicated description will be avoided.

The receiver b 6 includes the functions of the receiver 3 and the terminal 4 of the first embodiment.

As shown in FIG. 19, the receiver b 6 further includes a program receiving module 600, a signal selector module 601, an advertisement ID information separator module 602, a viewing confirming module 603, a viewing validity confirming module 604, an advertisement ID information accumulator module 605, a viewing information constructing module 606, a communication module 607, a gained point acquisition module 608, a video and audio output module 609, and a program recorder module 610.

The module 603 conducts an operation different from the operation of the viewing confirming module of the terminal 4 and hence description will be given. The other constituent components are almost equal in function and operation to those of the receiver 3 and the terminal 4 of the first embodiment, and hence duplicated description thereof will be avoided.

The receiver b 6 may be implemented by a set-top box or the like. In this case, it is suitable to dispose a viewing confirmation button on a remote controller, not on the receiver b 6. Therefore, if the button of the remote controller is depressed and a signal sent from the remote controller in response to the depression is received, the module 603 determines that the user is viewing advertisements. The module 603 then sends a signal indicating the depression of the button to the module 604. For example, according to the magnitude of the voltage, the signal represents whether the viewing button is being depressed. In the embodiment, the signal is transmitted by use of the remote controller. However, any device that a user places nearby and that transmits signals to the receiver b 6 may be adopted. Signals are desirably sent with high directivity or in a narrow communication range using, for example, an infrared ray.

Thanks to the configuration of the second embodiment, it is possible for the user to obtain, only by use of the receiver b 6, the advantage of the first embodiment. That is, the user can obtain an award from a sponsor by viewing advertisements.

The embodiments described above are only favorable embodiments and can be changed and modified in various ways within the scope of the present invention. For example, programs to implement the functions of the terminal 1, the transmitter 2, the receiver 3, the terminal 4, the terminal 5, and the receiver b 6 of the embodiments may be installed in the respective modules such that the respective functions are carried out by executing the programs. The programs may be transmitted to another computer system via a computer-readable recording medium, for example, a Compact Disk Read Only Memory (CD-ROM) or an optical disk or via a communication medium such as the Internet or a telephone line using transmission waves.

In the description of the embodiments, the terminal 1, the transmitter 2, the receiver 3, the terminal 4, the terminal 5, and the receiver b 6 are physically separated from each other and are connected to each other in the system configuration. However, each function may be included in one computer system, or a plurality of devices may be added for each function.

The present embodiments are also applicable to a broadcast system in which the broadcast company broadcasts free programs by inserting commercial advertisements in the programs and in which a user views a broadcast program in real time or views a recorded program. Specifically, the present embodiments are applicable to the digital and analog television broadcasting conducted by commercial broadcast companies. Also, the present embodiments are applicable to the radio program broadcasting and viewing.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. An advertisement viewing confirmation system, comprising:
a broadcast receiver terminal that receives a broadcast program with advertisement identification (ID) information inserted therein, outputs the program, and transmits the advertisement ID information through proximity communication; and
an advertisement viewing confirmation terminal that receives, if it is determined based on a temperature that a user is carrying about the advertisement viewing confirmation terminal, the advertisement ID information through proximity communication,
creates viewing information by adding user information to the advertisement ID information, and
confirms, according to the viewing information, that the broadcast program with the advertisement ID information inserted therein has been viewed by the user.

2. The advertisement viewing confirmation system in accordance with claim 1, wherein the advertisement ID information is inserted in the broadcast program in such a manner that the advertisement ID information is stored in a private stream of a Packetized Elementary Stream (PES) for a digital broadcast, or the advertisement ID information is superimposed onto a Vertical Blanking Interval (VBI) for an analog broadcast.

3. The advertisement viewing confirmation system in accordance with claim 1, wherein the advertisement viewing confirmation terminal accumulates points if it is confirmed according to the viewing information that the broadcast program with the advertisement ID information inserted therein has been viewed by the user; and notifies, if the accumulated points exceed a predetermined value, the user of an award to be gained by the points.

4. The advertisement viewing confirmation system in accordance with claim 1, wherein the advertisement viewing confirmation terminal discloses personal information of the user to a particular sponsor.

5. A broadcast receiver terminal being adapted or arranged to receive a broadcast program with advertisement ID information inserted therein, output the program, and transmit to an advertisement viewing confirmation terminal the advertisement ID information through proximity communication.

6. The broadcast receiver terminal in accordance with claim 5, wherein the advertisement ID information is inserted in the broadcast program in such a manner that the advertisement ID information is stored in a private stream of a PES for a digital broadcast, or the advertisement ID information is superimposed onto a Vertical Blanking Interval (VBI) for an analog broadcast.

7. An advertisement viewing confirmation terminal being adapted or arranged to receive, if it is determined based on a temperature that a user is carrying about the advertisement viewing confirmation terminal, a broadcast program with advertisement ID information inserted therein,
output the program,
create viewing information by adding user information to the advertisement ID information after receiving from a broadcast receiver terminal the advertisement ID information through proximity communication,
and confirm, according to the viewing information, that the broadcast program with the advertisement ID information inserted therein has been viewed by the user.

8. The advertisement viewing confirmation terminal in accordance with claim 7, wherein the advertisement ID information is inserted in the broadcast program in such a manner that the advertisement ID information is stored in a private stream of a PES for a digital broadcast, or the advertisement ID information is superimposed onto a Vertical Blanking Interval (VBI) for an analog broadcast.

9. The advertisement viewing confirmation terminal in accordance with claim 7, wherein the advertisement viewing confirmation terminal accumulates points if it is confirmed according to the viewing information that the broadcast program with the advertisement ID information inserted therein has been viewed by the user, and notifies, if the points thus accumulated exceed a predetermined value, the user of an award to be gained by the points.

10. The advertisement viewing confirmation terminal in accordance with claim 7, wherein the advertisement viewing confirmation terminal discloses personal information of the user to a particular sponsor.

11. An advertisement viewing confirmation method, comprising the steps of:
receiving by a broadcast receiver terminal a broadcast program with advertisement ID information inserted therein, outputting the program, and transmitting the advertisement ID information through proximity communication; and
receiving by an advertisement viewing confirmation terminal, if it is determined based on a temperature that a user is carrying about the confirmation terminal, the advertisement ID information through proximity communication, and creating viewing information by adding user information to the advertisement ID information; and
confirming by the confirmation terminal, according to the viewing information, that the broadcast program with the advertisement ID information inserted therein has been viewed by the user.

12. The advertisement viewing confirmation method in accordance with claim 11, further comprising the step of inserting the advertisement ID information in the broadcast program by storing the advertisement ID information in a private stream of a PES for a digital broadcast, or by superimposing the advertisement ID information onto a Vertical Blanking Interval (VBI) for an analog broadcast.

13. The advertisement viewing confirmation method in accordance with claim 11, further comprising the step of accumulating, by the advertisement viewing confirmation terminal, points if it is confirmed according to the viewing information that the broadcast program with the advertisement ID information inserted therein has been viewed by the user, and notifying, if the points thus accumulated exceed a predetermined value, the user of an award to be gained by the points.

14. The advertisement viewing confirmation method in accordance with claim 11, further comprising the step of disclosing, by the advertisement viewing confirmation terminal, personal information of the user to a particular sponsor.

15. A computer program for causing a computer to perform functions according to claim 1.
